(19) United States
(12) Patent Application Publication
(10) Pub. No.: US 2006/0216580 A1
(43) Pub. Date: Sep. 28, 2006

(54) Emergency power supply apparatus

(75) Inventor: Rudiger Schlosser, Schwabach (DE)

Correspondence Address: Leopold Presser;Scully, Scott, Murphy & Presser, 400 Garden City Plaza, Garden City, NY, 11530, US

(73) Assignee: Diehl Luftfahrt Elektronik GmbH, Nurnberg (DE)

(21) Appl. No.: 11/360,173

(22) Filed: Feb. 23, 2006

(30) Foreign Application Priority Data
Mar. 23, 2005 (DE) 10 2005 013351.7

(51) Int. Cl. H01M 2/10

(52) U.S. Cl. 429/97; 429/99

(57) ABSTRACT

An emergency power supply apparatus (1), in particular in an aircraft, having an appliance chassis (2) and having a battery housing (3) which can be fitted to it for holding a number of batteries or rechargeable batteries, with first latching elements (14, 16) being provided at the side on the battery housing (3) and interacting detachably with corresponding second latching elements (15), which are provided on the appliance chassis (2), in the form of a snap-action connection.

### BACKGROUND OF THE INVENTION

1. Field of the Invention

The invention relates to an emergency power supply apparatus, in particular for or in an aircraft, having replaceable rechargeable batteries or batteries.

An emergency power supply unit (EPSU) and, normally, a so-called autonomous standby power supply unit (ASPUS) are provided for safety reasons in an aircraft, in particular in passenger aircraft from the Airbus Company as well, with the aim of ensuring a reliable and in particular uninterruptible power supply for various appliance functions. Emergency power supply appliances such as these are generally fitted with replaceable batteries and/or rechargeable batteries.

When emergency power supply appliances such as these are being used correctly with appropriate battery arrangements, high accelerations during flight result in correspondingly high moments of inertia which are caused essentially by the intrinsic weight of the battery arrangement at accelerations of up to, for example, 6 g. For this reason, there is a requirement to provide suitable attachment means for battery arrangements such as these or emergency power supply appliances, which can absorb and withstand these moments of inertia or accelerations while complying with the safety criteria requirements. Since, furthermore, the life of such rechargeable batteries or battery arrangements is limited, for example, to five years, it is necessary to ensure reliable and fail-safe replaceability of such battery arrangements or battery blocks by maintenance personnel.

2. Discussion of the Prior Art

In order to ensure adequate firm seating, particularly at the battery block, on the one hand, and fail-safe replaceability of the battery or rechargeable battery block, on the other hand, a detachable screw connection can be used, but this must then satisfy the stringent aviation safety requirements. In this case, by way of example, it is feasible to use preferably four metric threaded screws with washers or shims as captive, detachable attachment elements on a housing holding the batteries or rechargeable batteries. Corresponding threaded nuts in the form of push-in parts are then pushed in, in a captive form, in an appliance chassis as part of the emergency power supply unit.

Attachment means such as these admittedly comply not only with the requirement for detachability for replacement of the batteries or rechargeable batteries but also provide at least relatively good attachment security, which can also relatively reliably absorb high moments of inertia resulting from high acceleration levels. However, the installation or removal of battery arrangements that have been mounted in this way is complex, not least because the attachment screws must be individually unscrewed and screwed up, and additional tools must be provided for this purpose.

### SUMMARY OF THE INVENTION

The invention is based on the object of providing an apparatus which can be installed safely and in particular is also convenient to install, for an emergency power supply apparatus of the type mentioned in the introduction.

According to the invention, this object is achieved by the features as described hereinbelow. For this purpose, the battery or rechargeable battery arrangement is provided in a preferably multiple part housing which is equipped on the outside thereof with latching elements which interact with mating latching elements that are provided in an appliance chassis, in the form of a snap-action or latching connection. Particularly preferable detachable locking of the snap-action or latching connection can be achieved in the form of a latching lock or in the form of an additional locking slide.

The invention is in this case based on the concept that a battery arrangement attachment which, on the one hand, is reliable and, on the other hand, can be handled easily, can be produced in an emergency power supply in an aircraft by producing an interlocking connection for a battery housing, which holds the batteries or rechargeable batteries, and an appliance chassis, in preferably two main load directions. The main load directions which are secured by the interlocking connection in this case preferably lie along the X axis and Y axis of a three-dimensional, Cartesian coordinate system. This results in the battery housing already being fixed in a securely installed position, in a captive form, in two of three main load directions.

The captive fixing or securing of the battery housing in the remaining third load direction which, subject to the preconditions mentioned above, extends in the direction of the Z axis, can then be produced in a simple and reliable manner by means of a snap-action connection or a latching lock. A reliable latching lock can in turn be produced in a simple reliable manner by additionally locking a detachable, preferably spring-loaded, latching or snap-action connection in the final installed state. A locking slide is particularly suitable for reliable removal of such a lock, and for ensuring that the latching or snap-action elements can be unlocked easily. This locking slide can be slid along the latching elements in such a way that they are locked or blocked in the locked position, and can move freely in the unlocked position in order to unlatch them.

In one expedient refinement, the battery housing is provided with snap-action hooks on opposite housing faces, which are themselves held at the end on snap-action hooks which can pivot, are at the same time preferably sprung or spring-loaded, and act in the form of lever arms. In order to connect the battery housing in a manner which is on the one hand reliable and on the other hand can be installed in a maintenance-friendly form, the snap-action hooks engage in latching eyes which are provided in a flush-mounted or frame base of the appliance chassis, and act in the form of undercuts. These undercuts are expediently formed into angled latching lugs. These are in turn formed by lugs which are formed from the chassis base or frame base, that is to say they are cut out or stamped out, and are angled in the direction of the battery housing. These (second) latching elements or eyes are in the form of sheet-metal lugs for an appliance chassis which is preferably in the form of a metal sheet, at least in the area of the holding frame for the battery housing.

The latching or lever arms to which the latching or snap-action hooks are fitted are integrally formed, preferably on the upper part of the battery housing, via connecting or fixing webs which run transversely with respect to these arms on the battery housing. This integral formation and configuration of the fixing webs is in this case designed in such a way that they act in the form of torsion springs, thus providing the desired spring effect of the snap-action hooks or of the lever arms. The snap-action hooks are in this case integrally formed on the lever arms, which are held on the battery housing such that they can pivot, at a distance from the pivoting axis of the lever arm. The free end of the lever arm opposite the respective snap-action hook is then used as an operating end for unlatching of the snap-action hooks from the respective snap-action connection or latch. The battery housing can be installed and removed using only one hand in a simple manner as a result of the arrangement of two physically identical lever arms, to which the snap-action hooks are fitted, on opposite faces of the battery housing.

The lever arms to which the respective snap-action hooks are fitted are integrally formed on the battery housing via fixing webs, which act in the form of torsion springs. The restoring force of the resiliently acting fixing webs in this case acts in the direction of the latching of the snap-action hooks with the latching eyes of the appliance chassis.

A contact for the batteries or rechargeable batteries is provided off-centre or asymmetrically on the housing base of the battery housing for correct installation of the battery housing in or on the appliance chassis. This off-centre or asymmetric arrangement of the contact in the area of the housing base defines the installation or joining direction for the battery housing, so that incorrect installation is virtually impossible. The removal direction then runs in the opposite direction to the installation or joining direction.

The battery housing, which is expediently in two parts, comprises a housing upper part and a housing lower part. The snap-action or latching hooks are integrally formed on the battery housing at the side and are thus an integral component of the battery housing. The snap-action hooks which form the first latching elements are in this case expediently an integral component of the housing upper part of the battery housing, which is formed from this and from the housing lower part. The two housing parts of the battery housing are detachably connected to one another, so that the batteries or rechargeable batteries can be replaced easily.

The battery housing is thus expediently composed of plastic, preferably of a glass-fibre-reinforced plastic. The rest position of the spring-loaded latching arms is in this case the latched position. The dimensions of the spring webs are in this case designed in such a way that, on the one hand, they ensure a reliable snap-action or latching connection and such that, on the other hand, the joining force and securing force which have to be applied for handling purposes are not too high to achieve sufficient maintenance friendliness.

The locking element which is associated with each latching element in the form of a snap-action hook and blocks the respective latching element when the battery housing is installed in the appliance chassis prevents inadvertent deflection of the respective snap-action hook when forces are applied during operation. The deflection torques of the sprung fixing webs or torsion elements may thus, as is known, possibly be inadequate on their own in order to ensure attachment of the battery housing such that it is secured in all feasible operating states of an aircraft. However, the additional locking of the snap-action or latching connection between the battery housing and the appliance chassis also reliably satisfies the stringent quality and security demands required in the field of aviation, in a simple manner.

The locking elements, which are expediently in the form of locking slides, are preferably integrated in the housing upper part of the battery housing. The locking elements, which are held on the battery housing at the side such that they can slide are in this case guided in corresponding housing recesses or grooves. The locking slides can thus be moved transversely with respect to the latching direction or latching deflection of the respective latching element in a simple manner, which is particularly maintenance-friendly, between the locked position which blocks the respective latching element and the unlocked position which releases the corresponding latching element for removal of the battery housing.

In one advantageous development, the locking elements or slides are in the form of frames. In the installed position, a lower frame side in this case rests on the respective latching element on its side facing away from the latching point. In the locked position, the respective latching element or the respective snap-action hook is thus blocked against inadvertent deflection with the consequence of undesirable unlatching of the snap-action connection. An upper frame side of the locking element which faces away from the respective snap-action hook engages behind the respective lever arm of the latching element when the battery housing is in the final installed position, at the pivoting or operating end facing away from this, so that the operating end of the lever arm is also blocked, in addition to the respective snap-action hook.

The advantages achieved by the invention are in particular that the design of a snap-action or latching connection which can expediently be locked or blocked between a battery housing and an appliance chassis holding it creates a securely installed attachment, which also complies with the safety requirements in aviation, for an emergency power supply apparatus. Furthermore, this ensures simple installation and removal for reliable maintenance of the emergency power supply. The aircraft emergency power supply designed with this attachment device can be installed and removed virtually without any tools and, in particular, just by using one hand. This leads in particular to a considerable time saving for maintenance of the emergency power supply, allowing a battery or rechargeable battery to be replaced with particularly little maintenance effort and in a particularly short time. In this case, correct installation is ensured by means of feedback, because the latching of the snap-action or latching connection between the battery housing and the appliance chassis can be identified topologically, visually, audibly and/or by touch.

### BRIEF DESCRIPTION OF THE DRAWINGS

One exemplary embodiment of the invention will be explained in more detail in the following text with reference to the drawings, in which:

FIG. 1 shows an exploded illustration of the apparatus according to the invention with an appliance chassis and a battery housing,

FIG. 2 shows a perspective illustration of the appliance chassis with a battery housing mounted on it,

FIG. 3 shows a perspective illustration of the appliance chassis with a holding frame for the battery housing,

FIG. 4 shows a perspective illustration of the battery housing mounted on a frame base of the appliance chassis, only part of which is illustrated,

FIG. 5 shows a perspective side view of the battery housing with an integrally formed latching element,

FIG. 6 shows the battery housing in an illustration as in FIG. 5, with an additional locking element,

FIG. 7 shows a section illustration through the battery housing latched to the appliance chassis with the lock open, and

FIG. 8 shows an illustration corresponding to that in FIG. 7 of the battery housing, latched to the appliance chassis, with the lock closed.

### DETAILED DESCRIPTION OF THE INVENTION

Mutually corresponding parts are provided with the same reference symbols in all of the figures.

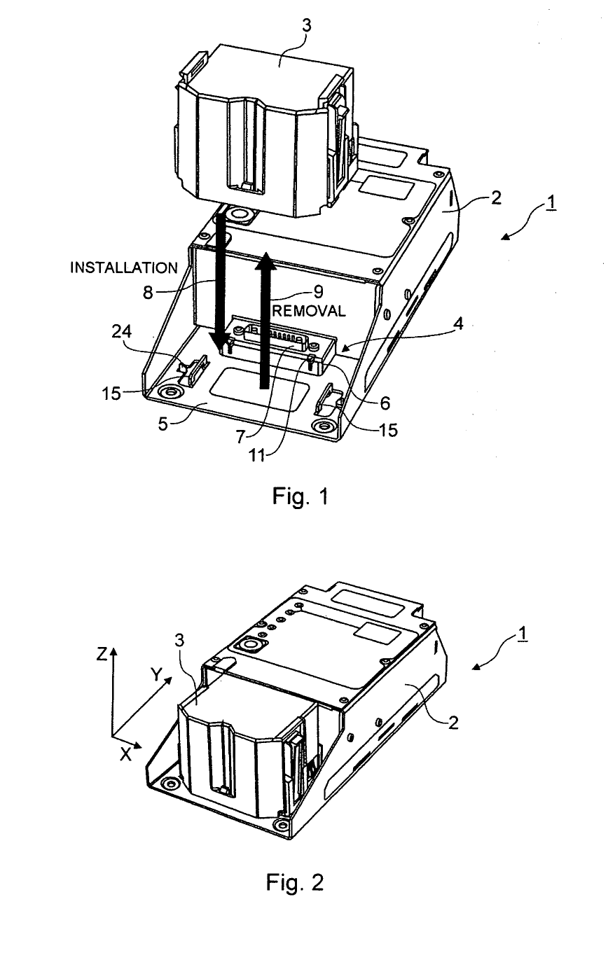

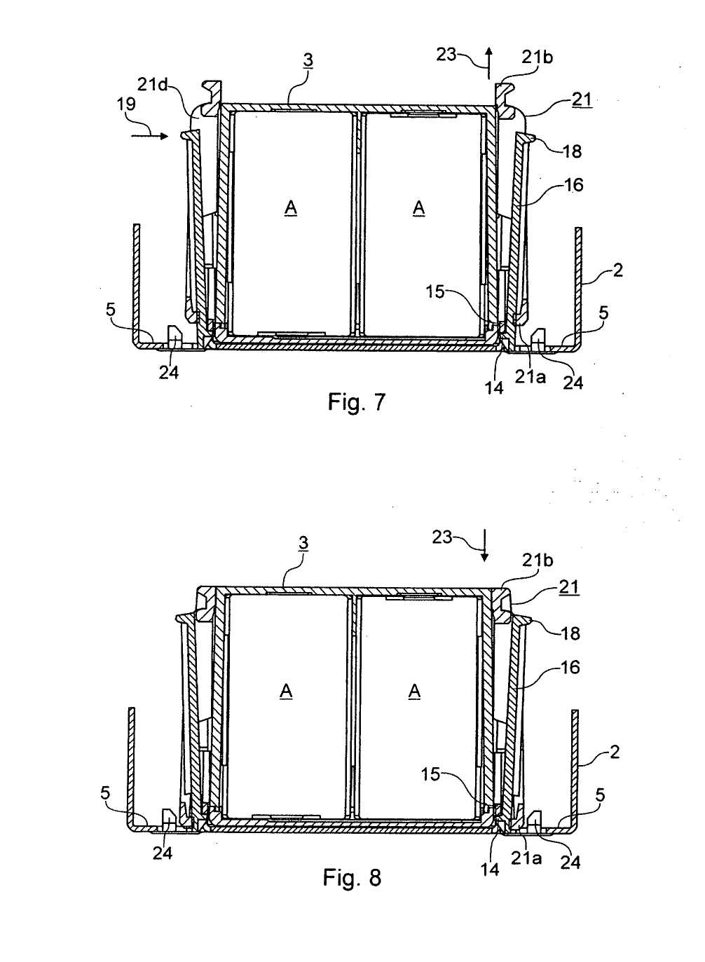

FIGS. 1 to 3 show an emergency power supply apparatus 1 as is used in an aircraft, with an appliance chassis 2 and with a battery housing 3. The battery housing 3 is used to hold batteries (which are not illustrated), in particular rechargeable batteries A (FIGS. 7, 8). While the battery housing 3 is preferably composed of plastic, the appliance chassis 2 is manufactured from a metal sheet, at least in the area of a holding frame 4 for the battery housing 3.

A contact-making cap 6 which projects like a dome from the frame or chassis base 5 of the appliance chassis 2 contains a contact-making strip 7, which makes contact with the corresponding contact-making strip (which cannot be seen) on the battery housing 3 in the installed state. For this purpose, a corresponding recess is provided in a manner which is not illustrated in any more detail in the base area of the battery housing 3, and the contact for the batteries or rechargeable batteries that have been inserted into the battery housing 3 is provided in this recess. The installation or joining direction of the battery housing 3, as indicated by the arrow 8, is thus defined by the contact between the battery housing 3 and the appliance chassis 2. The removal direction, which is indicated by the arrow 9, is in the opposite direction to the installation direction 8.

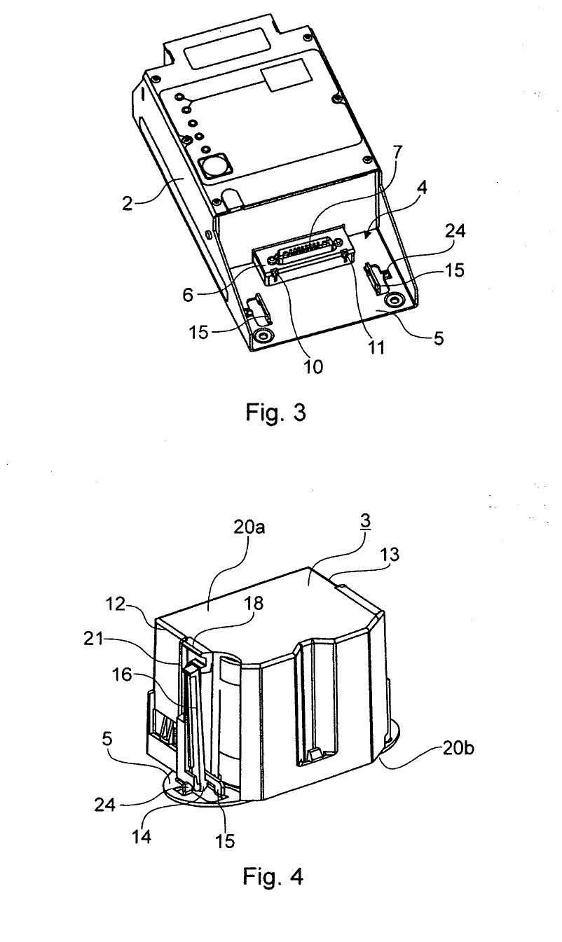

As can be seen in particular from FIG. 3, the contact-making cap 6 which projects like a dome from the chassis base 5 has two T-shaped holding grooves 10 and 11 at the end, in which pin elements (which cannot be seen) which are provided on the battery housing 3 engage. This advantageously means that two of three main load directions, specifically the main load directions along the x axis and along the y axis in the illustration shown in FIG. 2, are fixed by an interlocking connection of the battery housing 3 to the appliance chassis 2 and to its holding frame 4. This interlocking connection on its own ensures that the battery housing 3 is secured on the appliance chassis 2 on the xy plane against movement in the direction of the x axis and/or the y axis.

An attachment in order to avoid movement of the battery housing 3 in the third main load direction, that is to say in the direction of the z axis is ensured by first latching elements 14 being fitted at the side to the battery housing 3, on opposite housing faces 12, 13. These latching elements 14 are in the form of snap-action hooks, which interact with second latching elements 15 that are provided on the appliance chassis 2, in order to produce a latching or snap-action connection.

The second latching elements 15 act like latching eyes, which are formed by lugs that are formed from the sheet-metal base 5 of the appliance chassis 2 and/or of its holding frame 4 and are bent out at right angles. These second latching elements 15, which are referred to as latching lugs in the following text, preferably extend at right angles from the chassis base 5 in the z direction towards the battery housing ˜3. The latching lugs 15 in this case form an undercut for the snap-action hooks 14 which are provided at the side on the battery housing 3. FIGS. 4, 7 and 8 show the final installed state with the snap-action connection between the battery housing 3 and the appliance chassis 2.

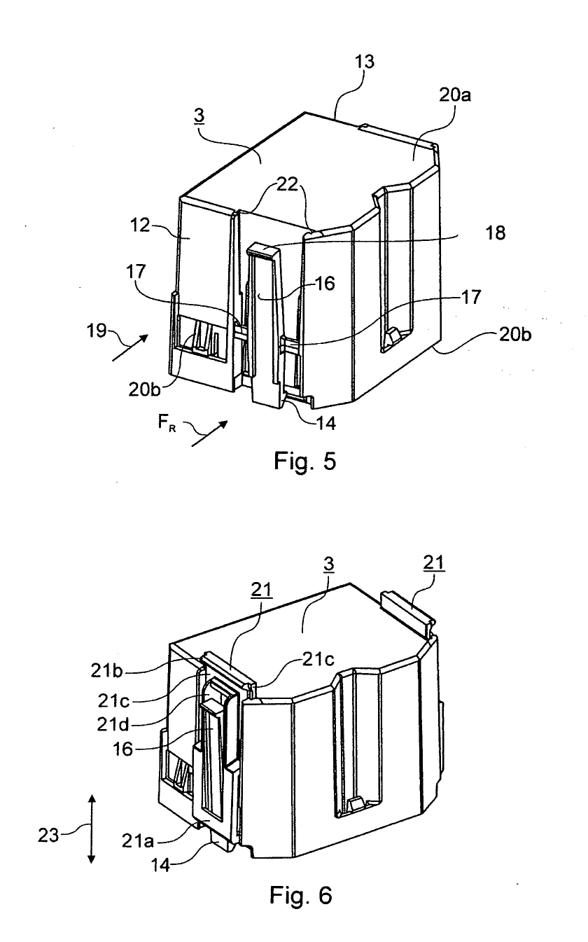

As can be seen comparatively clearly from FIG. 5, the snap-action hooks 14 are integrally formed at a free end of a lever arm 16 facing the base of the battery housing 3- and thus facing the chassis base 5 in the installed state. The lever arm 16 itself is integrally formed via fixing webs 17 on the respective housing face 12, 13 of the battery housing 3. The fixing webs 17 in this case carry out a plurality of functions. For example, these fixing webs 17 are used on the one hand for holding and fixing the first latching elements with the respective lever arm 16 and the snap-action hook 14, which is integrally formed on it, on the battery housing 3. Furthermore, the fixing webs 17 act like torsion springs and form a pivoting joint for the respective latching element 14, 16.

The restoring force F_{R} produced by the respective fixing web 17 in this case acts in the direction of the respective housing or side wall 12, 13 of the battery housing 3, and thus along the x axis as illustrated in FIG. 2. When the lever arm 16 is operated; at its free or operating end 18 that is opposite the snap-action hook 14, in the unlocking direction 19 (FIG. 5), the lever arm 16 is pivoted about the fixing webs 17, which at the same time act as a pivoting axis, with the consequence that the latching or snap-action connection 14, 15 is unlatched or released. During this process, an operator can use one hand to simultaneously operate two lever arms 16 which are arranged on the opposite housing faces 12, 13. In consequence, both snap-action hooks 14 are unlatched, so that the battery housing 3 can be removed manually.

The battery housing 3 has a housing upper part 20a and a housing lower part 20b. The housing parts 20a, 20b are composed of a glass-fibre-reinforced plastic. The two latching elements 14 which are provided on opposite housing faces 12, 13 on the respective lever arms 16 are expediently integrated in the housing upper part 20a. When the battery housing 3 is being fitted in the installation direction 3 and following the self-adjusting joining of the battery housing 3 to the appliance chassis 2, the respective snap-action hooks are automatically latched or snapped to the latching lugs 15. During the process, the fixing webs 17, which act like springs, rotate the respective snap-action hooks 14 back to the rest position after their installation deflection. The fixing webs 17, which act as corresponding spring elements, determine the joining and installation forces that need to be applied, on the basis of their material composition and their geometric dimensions.

These are, on the one hand, matched to adequate attachment security of the battery housing 3 to the appliance chassis 2 and, on the other hand, to a maintenance-friendly handling capability for removal of the battery housing 3.

Since the spring or restoring forces F_{R} of the fixing webs 17 should not be designed to be too high owing to the desired maintenance-friendliness, it is expedient to secure the latching elements or snap-action hooks 14 by means of additional locking elements 21 in order to avoid inadvertent deflection against the illustrated force direction 19 F_{R}. This compensates for possibly inadequate deflection torques of the fixing webs 17 which act like torsion springs, thus ensuring the required aviation quality and/or safety requirements are satisfied.

FIGS. 6 to 8 show the interaction of the locking elements 21 with the latching elements or snap-action hooks 14. The locking elements 21 themselves are in the form of frames—as can be seen comparatively clearly in FIG. 6. In this case, a lower frame side 21a, which faces the respective snap-action hook 14, of the locking element 21 rests on the respective lever arm 16 on its side facing away from the snap-action hook 14. The opposite upper frame side 21b of the locking element 21 is used as a gripping element for operation of the locking element 21. The comparatively long side frame or guide sides 21c of the locking element 21 are guided in locking beads or grooves 22 (FIG. 5), which are incorporated in the battery housing 3 at the side. Inner guide rails 21d of the locking element 21 in this case rest on both sides of the lever arm 16 in order to further improve the guidance of the locking element 21 in the battery housing 3. The locking element 21 can thus be moved in the sliding direction 23 parallel to the lever arm 16 of the respective latching element 14, 16.

The locking element 21, which is referred to in the following text as a locking slide, can thus be moved along the z axis, and in this case in the sliding direction 23, between an unlocked position as illustrated in FIG. 7 and a locked position as illustrated in FIG. 8. As can be seen comparatively clearly from FIG. 8, the lower frame side 21a of the locking slide 21 is preferably located in the appliance chassis 2 or its holding frame 4 as close to the bottom as possible, and thus underneath the snap-action hook 14 on the lever arm 16 of the respective snap-action hook 4. A guidance and locking element 24, which is formed from a chassis base 5 in the form of a lug that is bent out at right angles, prevents the snap-action hook 14 on the lever arm 16 together with the lower frame side 21a of the locking side 21 from becoming unlatched or released from the latching or snap-action connection with the latching lug 15. At the same time, the opposite upper frame side 21b of the locking slide 21 grips behind the operating end 18 of the lever arm 16 in such a way that it is blocked against movement or pivoting in the unlatching direction 19 (FIG. 5). The locking slide 21 thus blocks the respective lever arm 16 at both ends, and thus reliably prevents the corresponding latching element 14, 16 from being able to move both upwards and downwards.

In order to remove the battery housing 3, the locking slide 21 is first of all pushed upwards along the z axis in the sliding direction 23, once again using one hand. This opens the lock, so that the respective snap-action hook 14 and the respective latching element 14, 16 can move freely. The snap-action or latching connection is opened by subsequent operation of the latching element 14, 16 at the operating end 18 of the respective lever arm 16, so that the battery housing 3 can be removed.

When the battery housing 3 is subsequently installed again, it is placed on or inserted into the appliance chassis 2, with the interlocking connection being produced first of all, and with contact at the same time being made between the battery housing 3 and the appliance chassis 2. The battery housing 3 is automatically latched to the appliance chassis 2 subsequently or at the same time via the snap-action connection between the latching elements 14, 16 and the latching lugs 15 in the chassis or frame base 5 of the appliance chassis 2. Subsequent movement of the locking slide 21 in the sliding direction 23 blocks the latching or snap-action connection, so that this is locked in the form of a latching lock in order to prevent undesirable deflection of the snap-action hook 14 with the consequence of the snap-action connection 14, 15 being unlatched or opening.

### LIST OF REFERENCE SYMBOLS

1 Apparatus
2 Appliance chassis
3 Battery housing
4 Holding frame
5 Chassis/frame base
6 Contact-making cap
7 Contact-making strip
8 Fitting direction
9 Removal direction
10, 11 Holding groove
12, 13 Housing/side wall
14 (First) latching element/snap-action hook
15 (Second) latching element/latching lug
16 Lever arm
17 Fixing web
18 Operating end
19 Unlocking direction
20a Housing upper part
20b Housing lower part
21 Locking element/slide
21a Lower frame side
21b Upper frame side
21c Frame/guide side
22 Guide bead/groove
23 Sliding direction
B Battery/rechargeable battery

What is claimed is:

1. An emergency power supply apparatus (1) in an aircraft, having an appliance chassis (2) and a battery housing (3) which is fittable to said chassis for holding a quantity of batteries or rechargeable batteries (A), including first latching elements (14, 16) being provided at the side on the battery housing (3) for detachably cooperating with mating second latching elements (15) which are provided on the appliance chassis (2) in the form of a snap-action connection.

2. Apparatus according to claim 1, wherein at least one holding groove (10, 11) is provided in the appliance chassis (2) to form an interlocking connection with the battery housing (3).

3. Apparatus according to claim 2, wherein the interlocking connection is effective in two mutually orthogonal load directions (X, Y).

4. Apparatus according to claim 2, wherein the holding groove (10, 11) is provided in the area of a dome-like contact-making cap (6) on the appliance chassis (2) in order to make contact between the cap and the battery housing (3).

5. Apparatus according to claim 1, wherein the first latching elements (14) are integrally formed at a free end, upon facing the appliance chassis (2) in the installed state, of a lever arm (16) which is pivotably secured on the battery housing (3).

6. Apparatus according to claim 5, wherein the lever arm (16) is resiliently secured on the battery housing (3).

7. Apparatus according to claim 5, wherein the lever arm (16) is pivotably secured on the battery housing (3) via a fixing web (17) which acts in the form of a torsion spring.

8. Apparatus according to claim 5, wherein the lever arm (16) is integrally formed on the battery housing via a fixing web (17).

9. Apparatus according to claim 1, wherein the first latching elements (14) are in the form of snap-action hooks, and the second latching elements (15) are in the form of undercuts for latching eyes which form the first latching elements (14).

10. Apparatus according to claim 9, wherein the second latching elements (15) are in the form of lugs which are formed from a frame base (5) of the appliance chassis (2) and are angled in the direction of the battery housing (3), when the battery housing (3) has been fitted to the chassis.

11. Apparatus according to claim 1, wherein the first latching elements (14, 16) are locked when the battery housing (3) has been fitted to the chassis.

12. Apparatus according to claim 1, wherein a locking element (21) which is associated with the respective first latching element (14, 16) and is guided for movement between a locked position which blocks the respective latching element (14, 16), and an unlocked position which releases the corresponding latching element (14, 16) for removal from the battery housing (3).

13. Apparatus according to claim 12, wherein the locking element (21) is held on the battery housing (3) transversely slideable with respect to the latching direction (F_{R}, 19) of the respective first latching element (14, 16).

14. Apparatus according to claim 10, wherein the locking element (21) is in the form of a frame, having a lower frame face (21a) which faces the first latching element (14) resting on the latter when in the locked position on the side of the first latching element (14) facing away from the latch.

15. Apparatus according to claim 14, wherein the locking element (21) has an upper frame side (21b), which faces away from the first latching element (14) and, in a locked position, grips behind the lever arm (16) of the first latching element (14, 16) at the operating end (18) facing away from the latter, blocking the lever arm.

16. Apparatus according to claim 1, wherein the battery housing (3) has a housing lower part (20b) and a housing upper part (20a) on which, in each instance, one of the first latching elements (14, 16) is held on opposite housing faces (12, 13).

17. Apparatus according to claim 1, wherein the battery housing (3) is constituted of plastic, with the first latching hooks (14, 16) being integrally connected to the battery housing (3).

18. Apparatus according to claim 1, wherein the appliance chassis (2) is constituted of metal sheet at least in the area of a holding frame (4) for the battery housing (3).
